(19) United States
(12) Patent Application Publication
(10) Pub. No.: US 2014/0068265 A1
(43) Pub. Date: Mar. 6, 2014

(54) METHOD AND SYSTEM FOR TRANSMITTING DATA WITHIN A SECURE COMPUTER SYSTEM

(71) Applicant: Jess M. Irwin, McKinney, TX (US)

(72) Inventor: Jess M. Irwin, McKinney, TX (US)

(73) Assignee: Raytheon Company, Waltham, MA (US)

(21) Appl. No.: 13/599,812

(22) Filed: Aug. 30, 2012

(51) Int. Cl. H04L 9/32

(52) U.S. Cl. 713/170; 713/168

(57) ABSTRACT

Methods and systems related to the secure transmission of information within a vehicle's computing systems are presented. Transmitting a message within the secure computer system includes receiving a message that includes a remote encryption key from a module, validating the module, loading security metadata, then validating the security metadata using the remote encryption key. Thereafter, the valid destination modules are determined and the message is sent to them. Metadata labels may be securely attached to data using a local encryption key, in order to maintain the integrity of the data.

### BACKGROUND

The present invention relates to computer architectures. More specifically, the present invention relates to multi-processor computer architectures.

The avionics of conventional military and commercial systems is designed such that multiple embedded systems, i.e., radar, electronics, electro-optical and others, are coupled together in a platform avionics suite that is distributed throughout the vehicle to facilitate the flight of the vehicle and to improve the operation of the subsystems. In a modern military platform, disparate security classification guidelines may control the dissemination of information from each of those systems, and the external communications to other platforms and services. These systems may be coupled together in contemporary systems, sharing and combining the information for exploitation by the platform and its operator. The weapons system platforms may operate in a mode know as “System High,” even though the majority of information used is unclassified. System High mode is a level where all information in a platform operating in System High mode is treated as if the information is as restricted as the highest level of security classification available to the environment. In other words, in a platform operating in System High mode with a security classification of Top Secret, all information in that platform, even information that would otherwise be considered unclassified, is treated as if it were Top Secret.

Access to the stored results of any mission must be manually downgraded to the level of the end user, which may be that of a service member without any security clearance. Even the use of a government validated Cross-Domain Solution is limited by the ambiguity of the information to be released.

The primary approach to comply with DoD Instruction 8500.02 Information Assurance (IA) Implementation and the corresponding 8510.01 DoD Information Assurance Certification and Accreditation Process (DIACAP) is to demonstrate the control of information by documenting its flow to fulfill the three primary requirements of 8500.02. These primary requirements of confidentiality, integrity, and availability are intended to ensure that the intended user, and only the intended user, has timely access to the unmodified information based upon its sensitivity and need to know. In the past, physical isolation was used for this purpose. However, physical isolation can be a time consuming and expensive process and may not even be possible in modern systems. With the explosion of information technology, logical isolation has been proposed for isolation of network information traffic, using Common Internet Protocol Security Option (CIPSO) and Common Architecture Label IPv6 Security Option (CALIPSO). The use of COMSEC encryption with High Assurance Internet Protocol Encryptor (HAPIE) devices also provides isolation of network traffic. However, these approaches do not satisfy the requirement of fine-grained security where a large community of users need to share information of various levels of security without allowing an individual to expose information and place everyone at risk.

The need for a trusted operating system kernel has forced prior approaches to use a custom, multi-level, secure operating system. However, this approach has proven to be extremely expensive. Recently, NSA has issued guidance expressing disapproval of a common solution and requiring individual evaluation of each trusted solution. In the past, anything larger than a few thousand lines of code (or the hardware equivalent) has failed to pass evaluation. Hence, there is a need for an inexpensive security solution for integrated avionics.

### SUMMARY OF THE INVENTION

In one embodiment, a computer system may comprise: a plurality of nodes; and a primary node configured to provide a coupling between said plurality of nodes. The primary node may be configured to securely attach metadata labels to data. The metadata labels may include security instructions. The primary node may be configured to validate the metadata labels. The data may be transmitted to one or more of the plurality of nodes in accordance with the metadata labels. The primary node may be configured to encrypt data based on the security instructions.

In another embodiment, the primary node may be configured to create a local encryption key to cryptographically bind metadata labels to data messages. In another embodiment, the computer architecture is used to control a vehicle, such as an aircraft.

In another embodiment, the computer system may comprise a security metadata table; a module association table; and an external interface association table. The security metadata table may comprise a list of each module in the system, and the security metadata associated with each module. The module association table may comprise a connectivity map of each module within the computer system. The external interface association table may comprise information regarding external subsystems and the associated security metadata.

In another embodiment, the computer system may further comprise a processor configured to create and store a label authorization table which determines routing of data between nodes based on the metadata labels.

In another embodiment, a method of transmitting a message within a secure computer system may comprise: receiving a message including a remote encryption key from a module; validating the module; loading a security metadata table for the computer system; validating the security metadata data using the remote encryption key; reading a module association table to determine one or more valid destination modules; and sending the message to the one or more valid destination modules. In another embodiment, the method may further comprise cryptographically binding the security metadata to the message, using a local encryption key.

In another embodiment, the security metadata comprises information regarding the security of said message, including the security level of the message. In another embodiment, the destination module comprises an interface that allows external connection to the computer system. In another embodiment, the method may further comprise receiving a connection request from a destination node; comparing the connection request to said security metadata table; and transmitting said message if said security metadata table allows such a connection. In another embodiment, the method may further comprise: comparing said remote encryption key to said security metadata table; and transmitting said message if said security metadata table authorizes said remote encryption key.

In another embodiment, a method of transmitting a message within a secure computer system may comprise: parsing a message for transmission to determine a destination for the message; validating that the destination is connected; loading a security metadata table for the computer system; cryptographically binding the security metadata to the message; and sending the message to the one or more valid destination modules. The destination may be a local module within the computer system or an external interface to which other components may be coupled. The cryptographic binding may occur through the use of a local encryption key, which may later be used to decode the message at the destination.

### BRIEF DESCRIPTION OF THE DRAWINGS

FIG. 1 is a block diagram of a multi-level secure multi-processor computer architecture implemented in accordance with the teachings of the present invention.

FIG. 2 is a simplified block diagram of a multi-level secure multi-processor module implemented in accordance with the architecture of the present invention.

FIG. 3 is a flow chart illustrating the operation when a message is received by the primary node from an internal node to an internal node.

FIG. 4 is a flow chart illustrating the initialization of a system.

FIG. 5 is a flow chart illustrating the operation when a connection is requested from an external subsystem to the primary node.

FIG. 6 is a flow chart illustrating the operation when a message is received by the primary node from an external interface.

FIG. 7 is a flow chart illustrating the operation when a message is sent by the primary node to an external interface.

FIG. 8 is a flow chart illustrating the operation when an internal module sends a connection request to the primary node.

FIG. 9 is a flow chart illustrating the operation when a message is received by the primary node from an internal module

FIG. 10 is a flow chart illustrating the operation when a message is to be sent by the primary node to a module internal to the system.

### DETAILED DESCRIPTION

Illustrative embodiments and exemplary applications will now be described with reference to the accompanying drawings to disclose the advantageous teachings of the present invention.

While the present invention is described herein with reference to illustrative embodiments for particular applications, it should be understood that the invention is not limited thereto. Those having ordinary skill in the art and access to the teachings provided herein will recognize additional modifications, applications, and embodiments within the scope thereof and additional fields in which the present invention would be of significant utility.

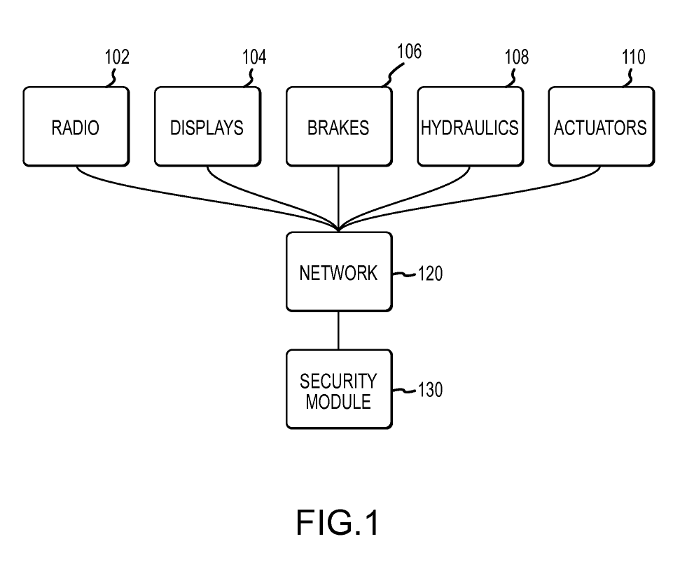

FIG. 1 is a block diagram of a multi-level secure multi-processor computer architecture implemented in accordance with the teachings of the present invention. In FIG. 1, multiple devices are each coupled to a network 120. These devices include many different systems of the aircraft, such as the radio 102, displays 104, brakes 106, hydraulics 108, actuators 110, and the like. Also coupled to the network is a security module 130.

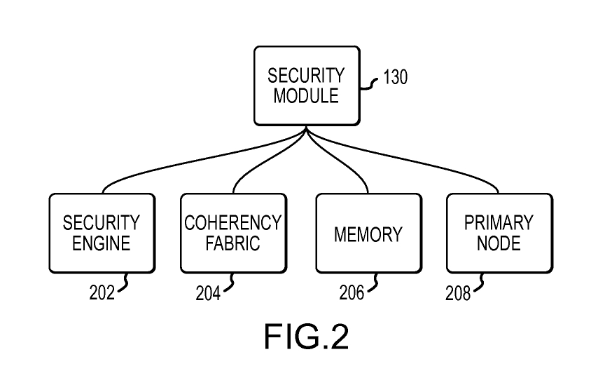

Security module 130 is illustrated further in FIG. 2. FIG. 2 is a simplified block diagram of a multi-level secure multi-processor computer implemented in accordance with the architecture of the present invention. Security module 130 comprises a security engine 202, coherency fabric 204, memory 206, and primary node 208. Primary node 208 serves as the controller or system manager, as part of an integrated avionics package.

An embodiment of the present invention operates through the use of security metadata that is securely attached to data transmitted through the system. By analyzing the security metadata, it can then be determined where the data can be sent. Because the data is encrypted before the security metadata is attached, the data is not accessible to people and systems that are not authorized to see the data. The operation of various scenarios is detailed below.

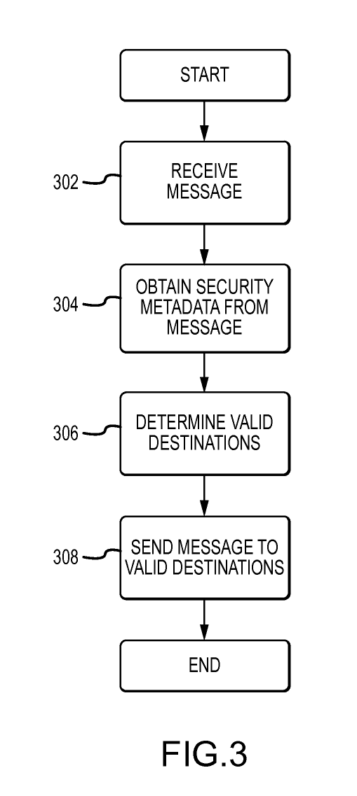

FIG. 3 is a flow chart illustrating the operation when a message is received by the primary node of a module from a node internal to the module to be sent to a node within the module. After the message is received (step 302), the message is parsed to obtain the security metadata from the message (step 304). The result metadata for the source node is compared to the table of security metadata for each node within the module to determine the valid destinations of the data (step 306). Each node within the module that has that exact security metadata in its table of allowed content is sent the message (step 308).

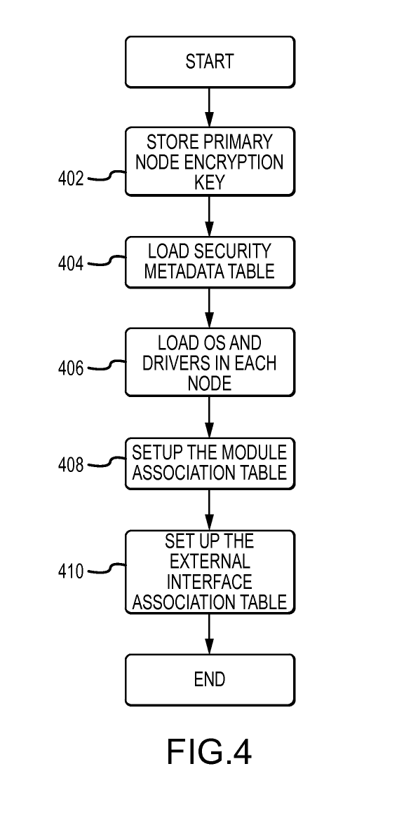

FIG. 4 is a flow chart illustrating how a system of an embodiment of this invention may be initialized. Upon initialization of the primary node of a module, the primary node encryption key is set and stored into volatile memory (step 402) and the security metadata table for the module and for each node in the module is loaded, with the minimal operating system, network stack, metadata based dissemination logic (step 404). The security metadata table contains a listing of each node and each module and the security levels associated with each module. In such a manner, it can be determined to which node data can be sent and the security level needs for such data transmission. Each node may be configured and loaded with a POSIX compliant operating system and virtual interface drivers that only communicate through the primary node (step 406). Each node is loaded with the connectivity map to other modules in the system and the interfaces that connect them—a module association table (step 408). An external interface association table is created and loaded into each control node (step 410). This table contains a list of external subsystems and services, the interface associated with each and its default security metadata. After the steps of FIG. 4 take place, the various nodes of the system are all configured and have stored the associations it has with each other node in the system.

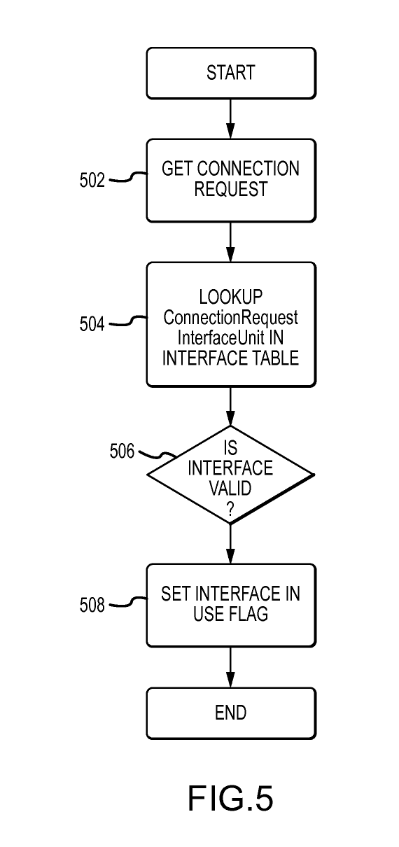

Various scenarios may then present themselves to an embodiment of the present invention. For example, FIG. 5 is a flow chart illustrating the operation when a connection is requested to the primary node of a module from an interface to an external subsystems or services in the system. After the connection request is received (step 502), the request is validated by comparing the request to the external interface association table described above (step 504). Because the external interface association table contains the valid associations to each node in the system, consulting with the external interface association table determines if the interface is valid (step 506). If the interface is valid, the connection is made and the interface is flagged as in use (step 508). Only one subsystem or service for each one each external interface is valid at a time.

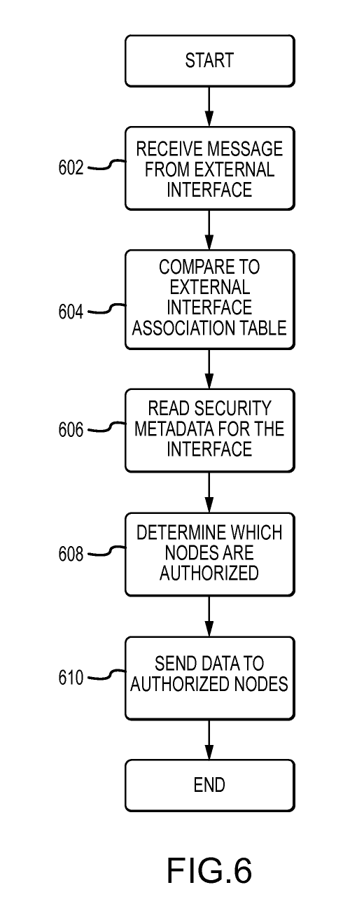

FIG. 6 is a flow chart illustrating the operation when a message is received by the primary node from an interface that is external to the system. After the message is received at the primary node (step 602), the interface is validated as connected and in use by comparing the request to the external interface association table (step 604). The security metadata is read for that interface (step 606). The metadata is parsed to determine which nodes are permitted to see the data (step 608). Thereafter, each node within the module that is authorized to see the data is sent the message (step 610).

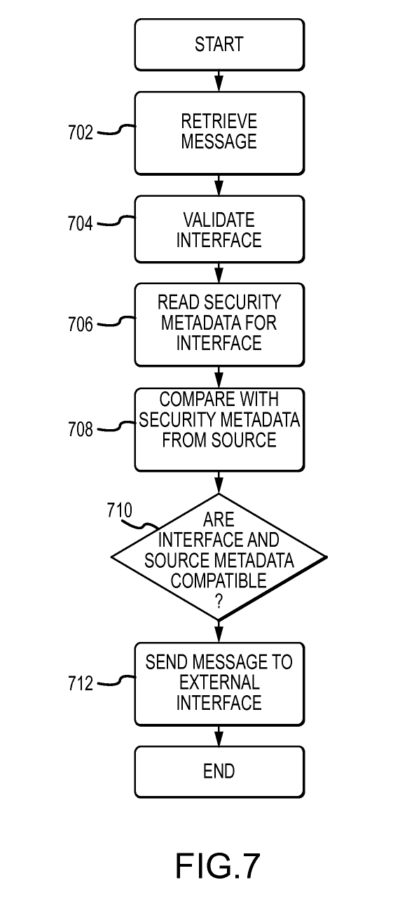

FIG. 7 is a flow chart illustrating the operation when a message is to be sent by the primary node to an interface that is external to the system. First, the primary node retrieves the message (step 702). Thereafter, the interface is validated as connected and in use (step 704). The external security metadata is read for that interface (step 706), and compared with the security metadata for the source node (step 708). If, and only if, the external interface security metadata and security metadata are compatible, then the message is sent to the external interface (step 710).

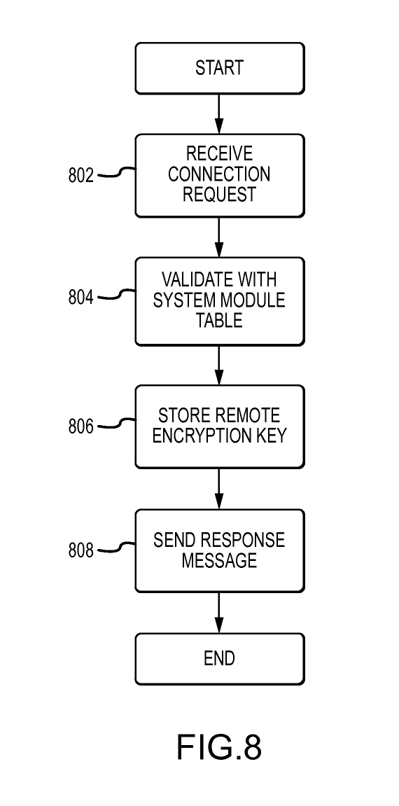

FIG. 8 is a flow chart illustrating the operation when a module internal to the system sends a connection request to the primary node. After the control node receives the connection request (step 802), the connection request is validated by reference to the system module table (step 804). If the module is valid, the remote encryption key that will be used to bind the security metadata associated with incoming messages is stored into the system module table (step 806) and a response message is sent that includes the local encryption key that is used to bind security metadata to be shared with that module (step 808).

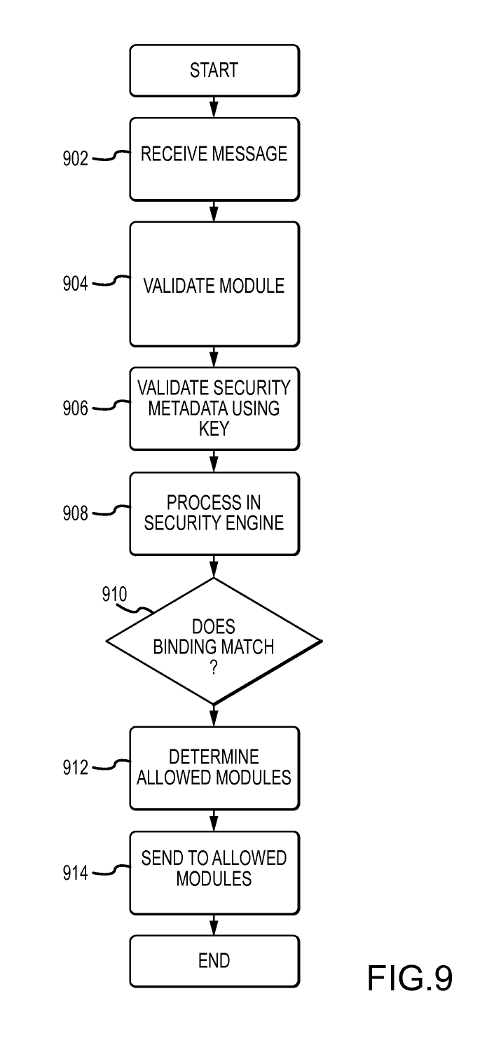

FIG. 9 is a flow chart illustrating the operation when a message is received by the primary node of a module from a module internal to the system. After the primary node receives the message, which includes a remote encryption key (step 902), the module is validated as being connected (step 904). Thereafter, the security metadata is validated for that module using the remote encryption key provided upon connection (step 906). The remote encryption key is processed in the security engine (step 908). Thereafter, the remote encryption key is evaluated to determine if the binding of the remote key matches (step 910). Then it is determined which nodes within the module have that exact security metadata in its table of allowed content by comparing the security metadata to a module association table (step 912), and those modules are sent the message (step 914).

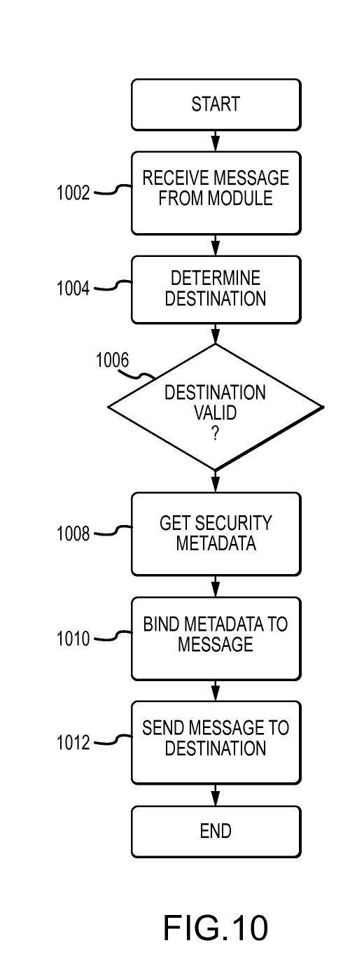

FIG. 10 is a flow chart illustrating the operation when a message is to be sent by the primary node to a module internal to the system. After receiving the message (step 1002), the message is parsed to determine the destination module (step 1004). The destination module is validated as being connected (step 1006). The security metadata for the source node is obtained (step 1008) and then cryptographically bound to the message using a local encryption key (step 1010). Thereafter, the message, security metadata, and binding are sent to the module, where it is later decoded using the local encryption key (step 1012). Because the message is encrypted, the message cannot be used by modules that are not authorized.

The present invention has been described herein with reference to a particular embodiment for a particular application. Those having ordinary skill in the art and access to the present teachings will recognize additional modifications, applications, and embodiments within the scope thereof.

The particular implementations shown and described are illustrative of the invention and its best mode and are not intended to otherwise limit the scope of the present invention in any way. Indeed, for the sake of brevity, conventional data processing, data transmission, and other functional aspects of the system may not be described in detail. Furthermore, the connecting lines shown in the various figures are intended to represent functional relationships and/or physical couplings between the various elements. Many alternative or additional functional relationships or physical connections may be present in a practical system.

In the foregoing description, the invention has been described with reference to specific exemplary embodiments. However, it will be appreciated that various modifications and changes may be made without departing from the scope of the present invention as set forth herein. The description and figures are to be regarded in an illustrative manner, rather than a restrictive one, and all such modifications are intended to be included within the scope of the present invention. Accordingly, the scope of the invention should be determined by the generic embodiments described herein and their legal equivalents rather than by merely the specific examples described above. For example, the steps recited in any method or process embodiment may be executed in any order and are not limited to the order presented in the specific examples. Additionally, the components and/or elements recited in any apparatus embodiment may be assembled or otherwise operationally configured in a variety of permutations to produce substantially the same result as the present invention and are accordingly not limited to the specific configuration recited in the specific examples.

It is therefore intended by the appended claims to cover any and all such applications, modifications and embodiments within the scope of the present invention.

What is claimed is:

1. A computer system comprising:
a plurality of nodes;
a primary node configured to provide a coupling between said plurality of nodes; wherein,
the primary node is configured to securely attach metadata labels to data, wherein said metadata labels include security instructions;
wherein the primary node is configured to validate the metadata labels;
wherein the data is transmitted to one or more of the plurality of nodes in accordance with the metadata labels; and
wherein said primary node is configured to encrypt data based on the security instructions.

2. The computer system of claim 1 wherein said primary node is configured to create a local encryption key to cryptographically bind metadata labels to data messages.

3. The computer system of claim 1 wherein said computer architecture is used to control a vehicle.

4. The computer system of claim 3 wherein said vehicle is an aircraft.

5. The computer system of claim 1 further comprising:
a security metadata table;
a module association table; and
an external interface association table; wherein
the security metadata table comprises a list of each module in the system, and the security metadata associated with each module;
the module association table comprises a connectivity map of each module within the computer system; and
the external interface association table comprises information regarding external subsystems and the associated security metadata.

6. The computer system of 5 further comprising:
a processor configured to create and store a label authorization table which determines routing of data between nodes based on the metadata labels.

7. A method of transmitting a message within a secure computer system comprising:
receiving a message including a remote encryption key from a module;
validating the module;
loading a security metadata table for the computer system;
validating the security metadata data using the remote encryption key;
reading a module association table to determine one or more valid destination modules; and
sending the message to the one or more valid destination modules.

8. The method of claim 7 further comprising:
cryptographically binding the security metadata to the message, using a local encryption key.

9. The method of claim 8 wherein said security metadata comprises information regarding the security of said message, including the security level of the message.

10. The method of claim 7 wherein said destination module comprises an interface that allows external connection to the computer system.

11. The method of transmitting a message of claim 7 further comprising:
receiving a connection request from a destination node;
comparing the connection request to said security metadata table; and
transmitting said message if said security metadata table allows such a connection.

12. The method of claim 11 further comprising:
comparing said remote encryption key to said security metadata table; and
transmitting said message if said security metadata table authorizes said remote encryption key.

13. A secure computer system comprising:
a processor configured to receive a message including a remote encryption key from a module;
a first validator configured to validate the module;
a loader configured to load a security metadata table for the computer system;
a second validator configured to validate the security metadata data using the remote encryption key;
a reader configured to read a module association table to determine one or more valid destination modules; and
a transmitter configured to send the message to the one or more valid destination modules.

14. The computer system of claim 13 further comprising:
a binder configured to cryptographically bind the security metadata to the message, using a local encryption key.

15. The computer system of claim 14 wherein said security metadata comprises information regarding the security of said message, including the security level of the message.

16. The computer system of claim 13 wherein said destination module comprises an interface that allows connection to the computer system.

17. The computer system of claim 13 further comprising:
a receiver configured to receive a connection request from a destination node;
a first comparer configure to compare the connection request to said security metadata table; and
wherein the transmitter is configured to transmit said message if said security metadata table allows such a connection.

18. The method of claim 17 further comprising:
a second comparer configured to comparing said remote encryption key to said security metadata table; and
wherein the transmitter is configured to transmit said message if said security metadata table authorizes said remote encryption key.

19. A method of transmitting a message within a secure computer system comprising:
parsing a message for transmission to determine a destination for the message;
validating that the destination is connected;
loading a security metadata table for the computer system;
cryptographically binding the security metadata to the message; and
sending the message to the one or more valid destination modules.

20. The method of claim 19 wherein:
said cryptographically binding comprises using a local encryption key to bind the security metadata to the message; and further comprising,
using the local encryption key to decode the message, at the valid destination.

21. The method of claim 19 wherein:
the destination is a local module within the computer system.

22. The method of claim 19 wherein:
the destination is an external interface.
